(19) United States
(12) Patent Application Publication
(10) Pub. No.: US 2026/0365029 A1
(43) Pub. Date: Nov. 19, 2026

(54) INSULATION RESISTANCE RECOVERY CONTROL METHOD AND APPARATUS OF FUEL CELL

(71) Applicants: Hyundai Motor Company, Seoul (KR); Kia Corporation, Seoul (KR)

(72) Inventors: Wang Sik JUNG, Hwaseong-si (KR); Jong Ik JEONG, Hwaseong-si (KR); Min Taek KIM, Hwaseong-si (KR); Sung Hyeon OH, Hwaseong-si (KR)

(21) Appl. No.: 19/459,644

(22) Filed: Jan. 26, 2026

(30) Foreign Application Priority Data
May 14, 2025 (KR) 10-2025-0062809

(51) Int. Cl. B60L 3/00; B60L 58/33; H01M 8/04044; H01M 8/04302; H01M 8/04303; H01M 8/0432; H01M 8/0438; H01M 8/04701; H01M 8/04746

(52) U.S. Cl. CPC B60L 3/0053; B60L 58/33; H01M 8/04044; H01M 8/04302; H01M 8/04303; H01M 8/04358; H01M 8/04417; H01M 8/04723; H01M 8/04768; H01M 2250/20

(57) ABSTRACT

Disclosed are an insulation resistance recovery control method and apparatus of a fuel cell. The method may include measuring an insulation resistance value of a fuel cell system of the vehicle; determining, based on the insulation resistance value, whether insulation resistance recovery control is necessary; determining a rotational speed of a pump of the fuel cell system based on determining that the insulation resistance recovery control is necessary, based on the fuel cell system transitioning to an inactive mode, based on a difference between the insulation resistance value and a threshold value, and based on a vehicle speed of the vehicle; and performing the insulation resistance recovery control by sending one or more control signals for: opening a valve, of the fuel cell system, that directs a coolant in the fuel cell system to an ion filter; and operating the pump at the determined rotational speed.

### CROSS-REFERENCE TO RELATED APPLICATION

This application claims the benefit of and priority to Korean Patent Application No. 10-2025-0062809, filed May 14, 2025 in the Korean Intellectual Property Office, the entire contents of which are incorporated herein by reference.

### TECHNICAL FIELD

The present disclosure relates to fuel cell vehicles and more particularly to insulation resistance recovery control of a fuel cell.

### BACKGROUND

A fuel cell system in hydrogen fuel cell vehicles may include various components such as a fuel cell stack, a hydrogen supply device, an air supply device, a thermal management system, and so forth. The fuel cell stack may generate electric energy from an electrochemical reaction between hydrogen and a reaction gas (e.g., air). The hydrogen supply device may supply hydrogen to an anode of the fuel cell stack. The air supply device may supply air to a cathode of the fuel cell stack. The thermal management system may release heat, which is a byproduct of the electrochemical reaction of the fuel cell stack, to the outside to optimally control the operating temperature of the fuel cell stack and perform a water management function.

A high-voltage battery may be also installed in the fuel cell vehicle to be charged with the electric energy generated in the fuel cell stack to store the electric energy. The high-voltage battery may thus be capable of directly supplying, to a driving motor of the fuel cell vehicle, the electric energy that was generated in the fuel cell stack, or outputting the electric energy stored in the high-voltage battery to high-voltage components and the driving motor of the fuel cell vehicle.

As these fuel cell vehicles are equipped with high-voltage batteries and the high-voltage components, it is important to maintain insulation resistance, which is represented by a resistance value indicating an electrical insulation performance. The reason for this is that, as the insulation resistance decreases, current may flow along an undesirable path and thus cause leakage, electric shocks, fires, etc.

Accordingly, in the fuel cell run (Fc Run) mode of a vehicle, where the fuel cell stack is used as a main power source for operating the vehicle by providing the electric energy generated by the fuel cell stack to the driving motor of the fuel cell vehicle, the insulation resistance of the fuel cell system including the fuel cell stack may be monitored.

Thus, in this mode, the insulation resistance of the fuel cell system may be considered the insulation resistance of the fuel cell vehicle equipped with the fuel cell system.

On the other hand, when the fuel cell vehicle is in the fuel cell stop (Fc Stop) mode (e.g., when the fuel cell vehicle idles or when the state of charge (SoC) of the high-voltage battery is greater than a reference value), the high-voltage battery may be used as the main power source. Thus, air supply to the fuel cell stack may be cut off and the output voltage of the stack may drop. When the Fuel cell vehicle is in the Fc Stop mode, the insulation resistance of the high-voltage battery may be monitored.

Further, when a coolant for cooling the fuel cell stack is circulated along a coolant circulation line during operation of the fuel cell system, metal ions may gradually be eluted from components installed in the coolant circulation line, including the fuel cell stack, and these metal ions may cause degradation in the insulation resistance.

Accordingly, if a result of the monitoring of the insulation resistance indicates that it is necessary to restore or rehabilitate the insulation resistance of the fuel cell vehicle or the fuel cell system thereof, an ion filter may be used to remove the metal ions from the coolant.

The ion filter may serve to remove the metal ions present in the coolant for cooling the fuel cell stack, etc., thereby enhancing the insulation performance of the fuel cell stack, that is, restoring the insulation resistance of the fuel cell stack.

In particular, the ion filter may include an ion exchange resin that is capable of physically separating out the metal ions from the coolant. The coolant that has circulated through the fuel cell stack may pass through the ion filter and then circulate back to the fuel cell stack after the metal ions are removed by the ion exchange resin in the ion filter. Thus, the level of metal ion content in the coolant (e.g., the electrical conductivity of the coolant) may be controlled below a certain level, and accordingly, the insulation resistance of the fuel cell stack may be restored.

However, although the coolant may be allowed to constantly flow through the ion filter to prevent gradual decrease in insulation resistance, the following problems may arise as the coolant is routed to the ion filter.

First, if the coolant is not channeled directly to the fuel cell stack and is rerouted to the ion filter instead during operation of the fuel cell system, loss in cooling performance of the fuel cell stack may occur, and this may limit the maximum performance of the fuel cell vehicle.

Second, in order to increase the amount of the coolant passing through the ion filter during operation of the fuel cell system, an opening degree of a valve that is controlled to allow the coolant to flow toward the fuel cell stack or the ion filter may be adjusted to a specific degree of valve opening so that the coolant flows only to the ion filter. Thus, in some situations, it may be difficult or impossible to control cooling of the fuel cell stack, such as when the coolant is not circulated back to the fuel cell stack for a long time. This may result in unexpected restrictions or degradations in the output of the fuel cell stack.

Third, as the amount of the coolant passing through the ion filter during operation of the fuel cell system increases, the lifespan of the ion filter may be rapidly shortened due to the raised temperature of the coolant, and accordingly, expenses may be incurred due to replacement of the ion filter.

The above information disclosed in this Background section is only for enhancement of understanding of the background of the disclosure and therefore it may contain information that does not form the prior art that is already known in this country to a person of ordinary skill in the art.

### SUMMARY

The present disclosure has been made in an effort to solve problems associated with at least some implementations of fuel cells and it is an aspect of the present disclosure to provide an insulation resistance recovery control method and apparatus of a fuel cell that enable insulation resistance recovery control using an ion filter to be performed in a fuel cell stop section in which a fuel cell stack does not generate power during operation of the fuel cell including fuel cell run and fuel cell stop, thereby enabling the insulation resistance of a fuel cell system to be easily restored and further guaranteeing the cooling performance of the fuel cell stack as a coolant is concentrated into the fuel cell stack in a fuel cell run section.

According to one or more example embodiments of the present disclosure, a method performed by an apparatus of a vehicle may include: measuring an insulation resistance value of a fuel cell system of the vehicle; determining, based on the insulation resistance value, whether insulation resistance recovery control is necessary; determining a rotational speed of a pump of the fuel cell system based on determining that the insulation resistance recovery control is necessary, based on the fuel cell system transitioning to an inactive mode, based on a difference between the insulation resistance value and a threshold value, and based on a vehicle speed of the vehicle; and performing the insulation resistance recovery control by sending one or more control signals for: opening a valve, of the fuel cell system, that directs a coolant in the fuel cell system to an ion filter; and operating the pump at the determined rotational speed.

Determining whether the insulation resistance recovery control is necessary may include: determining that the insulation resistance recovery control is necessary based on the insulation resistance value, measured while the fuel cell system is in an active mode, is less than a predetermined insulation resistance lower limit.

Determining the rotational speed may include: determining the rotational speed further based on determining that an average temperature of the coolant is less than a threshold temperature.

Determining the rotational speed may include: determining the rotational speed further based on a difference between a predetermined quantity of moving averages of insulation resistance values, measured before the fuel cell system transitions to the inactive mode, and a predetermined insulation resistance upper limit.

The method may further include: determining, during the insulation resistance recovery control, whether a release condition for the insulation resistance recovery control is satisfied.

The release condition for the insulation resistance recovery control may include at least one of: the fuel cell system transitioning from the inactive mode to an active mode, or the coolant passing through the ion filter for at least a predetermined time duration while the fuel cell system is in the inactive mode.

The insulation resistance recovery control may be first insulation resistance recovery control. The method may further include: based on determining that the release condition is satisfied, comparing a second insulation resistance value, measured after the first insulation resistance recovery control, with a predetermined insulation resistance upper limit; and performing one of: based on the second insulation resistance value being less than the predetermined insulation resistance upper limit and based on the fuel cell system transitioning to the inactive mode after the first insulation resistance recovery control, second insulation resistance recovery control, or, based on the second insulation resistance value being greater than the predetermined insulation resistance upper limit, determining that the second insulation resistance recovery control is unnecessary.

According to one or more example embodiments of the present disclosure, a method performed by an apparatus of a vehicle may include: measuring an insulation resistance value of a fuel cell system of the vehicle; determining, based on the insulation resistance value, whether insulation resistance recovery control is necessary; determining a rotational speed of a pump of the fuel cell system based on a difference between the insulation resistance value and a threshold value, based on a vehicle speed of the vehicle, and based on determining that the fuel cell system remains in an inactive mode for at least a predetermined waiting time duration after determining that the insulation resistance recovery control is necessary; and performing, for an execution time duration, the insulation resistance recovery control by sending one or more control signals for: opening a valve, of the fuel cell system, that directs a coolant in the fuel cell system to an ion filter; and operating the pump at the determined rotational speed.

Determining whether the insulation resistance recovery control is necessary may include: determining that the insulation resistance recovery control is necessary based on the insulation resistance value being less than a predetermined insulation resistance lower limit.

The method may further include: lowering a target cooling temperature of the fuel cell system by a cooling margin; and determining, based on the cooling margin, the execution time duration.

Determining the rotational speed may include: determining the rotational speed further based on a difference between a predetermined quantity of moving averages of insulation resistance values, measured while the fuel cell system is in an active mode, and a predetermined insulation resistance upper limit.

The method may further include: determining, during the insulation resistance recovery control, whether a release condition for the insulation resistance recovery control is satisfied.

The release condition for the insulation resistance recovery control may include at least one of: a current coolant temperature of the coolant in the fuel cell system exceeding a target cooling temperature, elapsing of the execution time duration, or the insulation resistance value exceeding a predetermined insulation resistance upper limit.

The insulation resistance recovery control may be first insulation resistance recovery control. The method may further include: based on determining that the release condition is satisfied, comparing a second insulation resistance value, measured after the first insulation resistance recovery control, with a predetermined insulation resistance upper limit; and performing one of: based on the second insulation resistance value being less than the predetermined insulation resistance upper limit and based on the fuel cell system transitioning to the inactive mode after the first insulation resistance recovery control, second insulation resistance recovery control, or, based on the second insulation resistance value being greater than the predetermined insulation resistance upper limit, determining that the second insulation resistance recovery control is unnecessary.

According to one or more example embodiments of the present disclosure, an apparatus may include: an insulation resistance sensor configured to monitor insulation resistance of a fuel cell system of a vehicle; a processor; and a memory. The memory may store at least one instruction that is configured to be executed by the processor to cause the apparatus to: receive, from the insulation resistance sensor, an insulation resistance value of the fuel cell system; determine, based on the insulation resistance value, whether insulation resistance recovery control is necessary; determine a rotational speed of a pump of the fuel cell system based on a difference between the insulation resistance value and a threshold value, and based on a vehicle speed of the vehicle; and perform the insulation resistance recovery control by sending one or more control signals for: opening a valve, of the fuel cell system, that directs a coolant in the fuel cell system to an ion filter; and operating the pump at the determined rotational speed.

The at least one instruction is configured to be executed by the processor to cause the apparatus to determine the rotational speed by one of: determining the rotational speed further based on the fuel cell system transitioning to an inactive mode, and based on determining that the insulation resistance recovery control is necessary, or determining the rotational speed further based on determining that the fuel cell system remains in the inactive mode for at least a predetermined waiting time duration after determining that the insulation resistance recovery control is necessary.

The at least one instruction is configured to be executed by the processor to cause the apparatus to determine the rotational speed by: determining the rotational speed further based on determining that an average temperature of the coolant is less than a threshold temperature, based on the fuel cell system transitioning to an inactive mode, and based on a difference between a predetermined quantity of moving averages of insulation resistance values, measured before the fuel cell system transitions to the inactive mode, and a predetermined insulation resistance upper limit.

The at least one instruction is configured to be executed by the processor to further cause the apparatus to: lower a target cooling temperature of the fuel cell system by a cooling margin; and determine, based on the cooling margin, an execution time duration of the insulation resistance recovery control. The at least one instruction is configured to be executed by the processor to cause the apparatus to determine the rotational speed by: determining the rotational speed further based on a difference between a predetermined quantity of moving averages of insulation resistance values, measured while the fuel cell system is in an active mode, and a predetermined insulation resistance upper limit.

The at least one instruction is configured to be executed by the processor to further cause the apparatus to: determine, during the insulation resistance recovery control, that a release condition for the insulation resistance recovery control is satisfied based on at least one of: the fuel cell system transitioning from an inactive mode to an active mode, or the coolant passing through the ion filter for at least a predetermined time duration while the fuel cell system is in the inactive mode.

The at least one instruction is configured to be executed by the processor to further cause the apparatus to: determine, during the insulation resistance recovery control, that a release condition for the insulation resistance recovery control is satisfied based on at least one of: a current coolant temperature of the coolant in the fuel cell system exceeding a target cooling temperature, elapsing of an execution time duration of the insulation resistance recovery control, or the insulation resistance value exceeding a predetermined insulation resistance upper limit.

Other aspects and preferred embodiments of the disclosure are discussed infra.

The above and other features of the disclosure are discussed infra.

### BRIEF DESCRIPTION OF THE DRAWINGS

The above and other features of the present disclosure will now be described in detail with reference to one or more example embodiments thereof illustrated the accompanying drawings which are given hereinbelow by way of illustration only, and thus are not limitative of the present disclosure, and wherein:

FIGS. 1 and 2 are schematic diagrams showing an example insulation resistance recovery control apparatus of a fuel cell;

FIG. 3 is a schematic diagram showing an example insulation resistance recovery control apparatus of a fuel cell;

FIGS. 4A and 4B are flowcharts illustrating an example insulation resistance recovery control method of a fuel cell; and

FIG. 5 shows an example computing system.

It should be understood that the appended drawings are not necessarily to scale, presenting a somewhat simplified representation of various features illustrative of the basic principles of the present disclosure. The specific design features of the present disclosure as disclosed herein, including, for example, specific dimensions, orientations, positions, and shapes will be determined in part by the particular intended application and use environment.

In the figures, reference numbers refer to the same or equivalent parts of the present disclosure throughout the several figures of the drawing.

### DETAILED DESCRIPTION

Specific structural or functional descriptions set forth in one or more embodiments of the present disclosure are examples given to describe the concept of the present disclosure, and the example embodiment(s) of the present disclosure may be embodied in different forms. In addition, the present disclosure should not be construed as being limited to the example embodiment(s) set forth herein, and it will be understood that the present disclosure includes all modifications, equivalents, or substitutes included in the spirit and technical scope of the disclosure.

In the following description of the example embodiment(s), terms, such as “first,” “second,” and the like, are used only to describe various elements, and these elements should not be construed as being limited by these terms. These terms are used only to distinguish one element from other elements. For example, a first element described hereinafter may be termed a second element, and similarly, a second element described hereinafter may be termed a first element, without departing from the scope of the disclosure.

For purposes of the present application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

When an element or layer is referred to as being “on,” “engaged with,” “connected to,” or “coupled to” another element or layer, it may be directly on, engaged with, connected to, or coupled to the other element or layer, or intervening elements or layers may be present. In contrast, when an element is referred to as being “directly on,” “directly engaged with,” “directly connected to,” or “directly coupled to” another element or layer, there may be no intervening elements or layers present. Other words used to describe the relationship between elements, e.g., “between” versus “directly between,” “adjacent” versus “directly adjacent,” etc., should be interpreted in a like fashion.

Wherever possible, the same reference numbers will be used throughout the following description to refer to the same or like parts. The terminology used herein is for the purpose of describing particular example embodiment(s) only and is not intended to be limiting. As used herein, singular forms may be intended to include plural forms as well, unless the context clearly indicates otherwise. The terms “comprises,” “comprising,” “including,” and “having” are inclusive and therefore specify the presence of stated features, integers, operations, operations, elements, components, and/or combinations thereof, but do not preclude the presence or addition of one or more other features, integers, operations, operations, elements, components, and/or combinations thereof.

Hereinafter, reference will be made in detail to one or more example embodiments of the present disclosure, examples of which are illustrated in the accompanying drawings and described below.

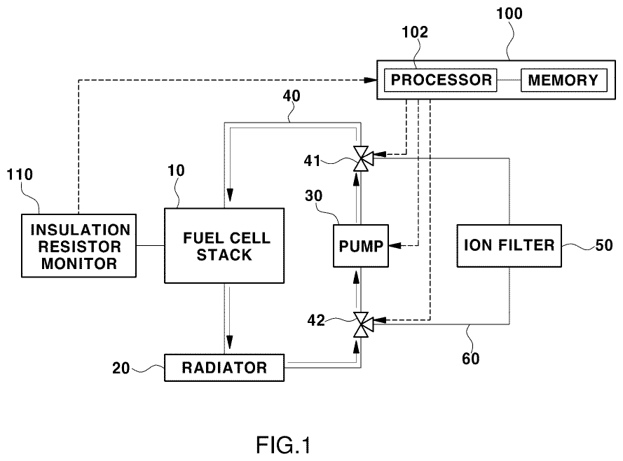

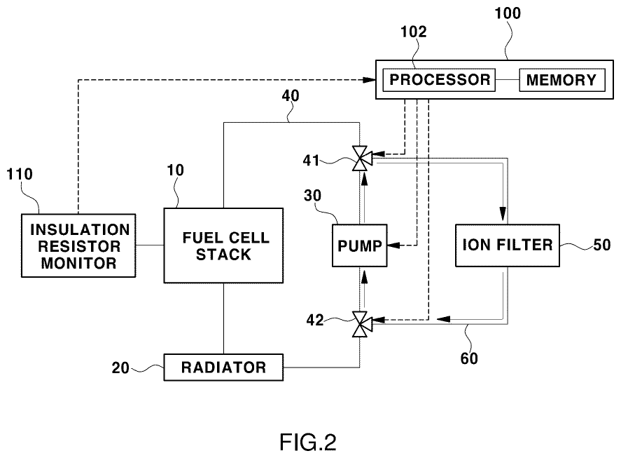

FIGS. 1 and 2 are schematic diagrams showing an example insulation resistance recovery control apparatus of a fuel cell.

As shown in FIGS. 1 and 2, a fuel cell stack 10, a radiator 20, and a pump 30 are connected by a coolant circulation line 40 to enable a coolant to be circulated therebetween.

As valves for controlling the flow direction of the coolant to the fuel cell stack 10 or an ion filter 50, a three-way type first valve 41 may be mounted on the coolant circulation line 40 between a coolant outlet of the pump 30 and a coolant inlet of the fuel cell stack 10, and a three-way type second valve 42 may be mounted on the coolant circulation line 40 between a coolant outlet of the radiator 20 and a coolant inlet of the pump 30.

In addition, the first valve 41, the ion filter 50, and the second valve 42 are connected by a coolant branch line 60 to enable the coolant to be circulated therebetween.

Here, the first valve 41 and the second valve 42 may be electric three-way valves, opening of which may be adjusted by a current control signal from a controller (also referred to as controlling circuit) 100, and the operational rotational speed (e.g., revolutions per minute (RPM)) of the pump 30 may be varied according to a control signal from the controller 100.

The first valve 41 and the second valve 42 may be electric four-way or five-way valves, opening of which may be adjusted by a current control signal from the controller 100.

Particularly, the ion filter 50 removes metal ions eluted in the coolant when the coolant is circulated through the fuel cell stack 10, etc., thereby restoring the insulation resistance of a fuel cell system.

Further, the controller 100 includes a processor and a memory for insulation resistance recovery control, and is configured to determine opening of the first valve 41 and the second valve 42, the opening direction of the first valve 41 and the second valve 42, and the operational rotational speed of the pump 30 based on a monitoring signal from an insulation resistance monitor 110 that monitors the insulation resistance of the fuel cell system.

In more detail, the controller 100 includes at least one processor 102 that determines whether insulation resistance recovery control is necessary based on a result of the monitoring of the insulation resistance monitor 110, determines the rotational speed of the pump based on an insulation resistance deviation and a vehicle speed for the insulation resistance recovery control or forced insulation resistance recovery control, and controls the first valve 41 and the second valve 42 to be opened (e.g., fully opened) in a direction of circulating the coolant to the ion filter 50 for the insulation resistance recovery control or the forced insulation resistance recovery control, and pump 30 to be driven 30 at the determined rotational speed of the pump.

Here, the insulation resistance monitor 110 may be a fuel stack voltage monitor (FSVM) that is mounted in the fuel cell stack to measure insulation resistance from among components of the fuel cell system. For example, the insulation resistance monitor 110 may be a insulation resistance tester or megohmmeter.

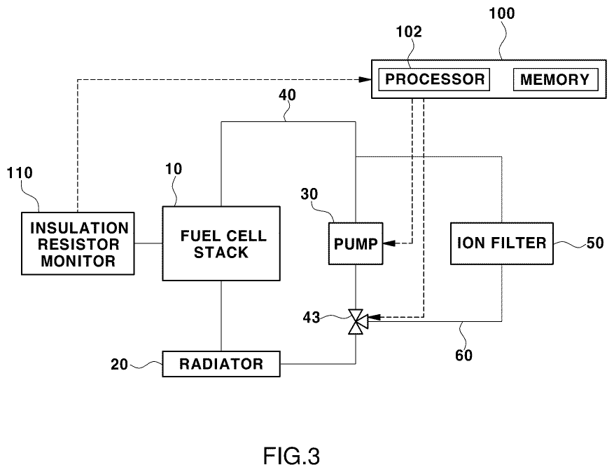

FIG. 3 is a schematic diagram showing an example insulation resistance recovery control apparatus of a fuel cell. As shown in FIG. 3, as a valve for controlling the flow direction of a coolant to a fuel cell stack 10 or an ion filter 50, a single valve 43 that may be one of electric three-way, four-way, and five-way valves may be provided, and the valve 43 may be mounted at a position where a coolant circulation line 40 connected to a coolant inlet of a pump 30 and a coolant branch line 60 extending toward the ion filter 50 meet.

Here, an insulation resistance recovery control method of a fuel cell based on the above-described configuration is sequentially examined as follows.

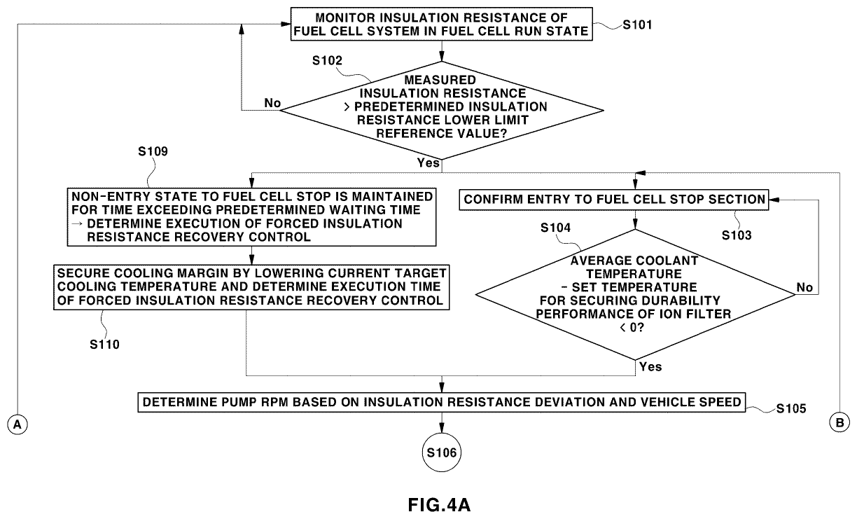

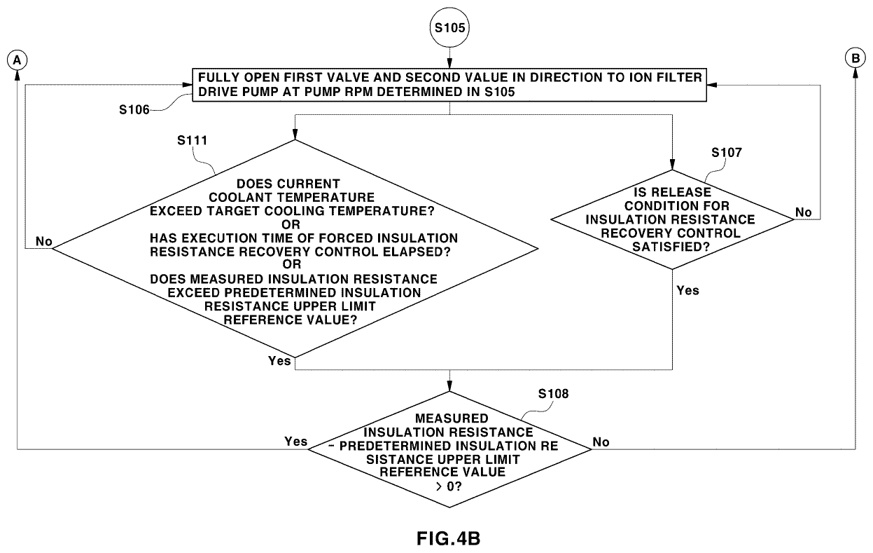

FIGS. 4A and 4B are flowcharts illustrating an example insulation resistance recovery control method of the fuel cell.

First, the insulation resistance of a fuel cell system is monitored in a fuel cell run state (S101). The fuel cell run state, in which fuel is supplied to the fuel cell stack of the fuel cell system and the fuel cell system actively generates and supply power (e.g., electricity) to the vehicle, may also be referred to as fuel cell run mode, fuel cell active state or mode, fuel cell operating state or mode, fuel cell power generation state or mode, fuel cell engaged state or mode, etc.

For example, in a fuel cell run mode in which a fuel cell stack is used as a main power source, such as when electric energy generated from the fuel cell stack is output to a driving motor during driving of a fuel cell vehicle, the insulation resistance of the fuel cell system is measured in real time by the insulation resistance monitor 110, and the measured insulation resistance information may be provided to the controller 100.

Thereafter, based on a result of the monitoring of the insulation resistance, the controller 100 determines whether insulation resistance recovery control is necessary.

For this purpose, the controller 100 compares the insulation resistance measured by the insulation resistance monitor 110 with a predetermined insulation resistance lower limit reference value.

That is, the controller 100 determines whether a value obtained by subtracting the predetermined insulation resistance lower limit reference value from the insulation resistance measured by the insulation resistance monitor 110 is less than 0 (zero) (e.g., whether the predetermined insulation resistance lower limit reference value is greater than the insulation resistance measured by the insulation resistance monitor 110) (S102).

When the insulation resistance measured by the insulation resistance monitor 110 is less than the predetermined insulation resistance lower limit reference value as a result of the determination in S102, the controller 100 determines that the insulation resistance recovery control by the ion filter 50 is necessary.

In the fuel cell run state, in order to secure reliability of the insulation resistance measurement value of the fuel cell system, when a predetermined quantity of (e.g., n-time) moving averages (also referred to as rolling averages or running averages) of insulation resistances measured by the insulation resistance monitor 110 is less than the predetermined insulation resistance lower limit reference value, the controller 100 determines that the insulation resistance recovery control by the ion filter 50 is necessary.

On the other hand, in the fuel cell run state, when the n-time moving average of the insulation resistances measured by the insulation resistance monitor 110 exceeds a predetermined insulation resistance upper limit reference value, the controller 100 may determine that insulation resistance recovery control by the ion filter 50 is unnecessary.

At this time, when the insulation resistance recovery control by the ion filter 50 is determined to be unnecessary, the first valve 41 and the second valve 42 are maintained in an open state in a direction of circulating the coolant to the fuel cell stack 10 by a control signal from the controller 10, as shown in FIG. 1 in the fuel cell run state, so that the coolant is not circulated to the ion filter 50 but is concentratedly circulated to the fuel cell stack 10, thereby preventing the cooling loss of the fuel cell stack in the fuel cell run mode, which is the operating state of the fuel cell system, and thus improving cooling performance.

Thereafter, the controller 100 determines whether the fuel cell system enters (e.g., switches or transitions to) a fuel cell stop mode where the high-voltage battery is used as the main power source when the fuel cell vehicle idles, in which the output voltage of the fuel cell stack drops as air supply to the fuel cell stack is cut off (S103).

Subsequently, when it is determined that the fuel cell vehicle enters the fuel cell stop mode, the controller 100 compares an average coolant temperature with a set temperature for ensuring the durability of the ion filter 50.

In other words, the controller 100 determines whether a value obtained by subtracting the set temperature for ensuring the durability of the ion filter 50 from the average coolant temperature is less than 0 (zero) (e.g., whether the average coolant temperature is less than the set temperature for ensuring the durability of the ion filter 50) (S104).

At this time, the average coolant temperature may be an average value of a coolant temperature measured by a temperature sensor at the inlet of the fuel cell stack and a coolant temperature measured by a temperature sensor at the outlet of the fuel cell stack.

As a result of the determination in S104, if the value obtained by subtracting the set temperature for ensuring the durability of the ion filter 50 from the average coolant temperature is less than 0 (zero) (e.g., if the average coolant temperature is less than the set temperature for ensuring the durability of the ion filter 50), the controller 100 determines a rotational speed of the pump depending on an insulation resistance deviation (e.g., how much the measured insulation resistance deviates from a threshold value) and a vehicle speed (S105).

For this purpose, the processor 102 of the controller 100 may be configured to determine the rotational speed of the pump based on the insulation resistance deviation and the vehicle speed for the insulation resistance recovery control, if the value obtained by subtracting the set temperature for ensuring the durability of the ion filter 50 from the average temperature of the coolant is less than 0 (zero) (e.g., if the average temperature of the coolant is less than the set temperature for ensuring the durability of the ion filter 50) after determining that insulation resistance recovery control is necessary and confirming entrance of the fuel cell system to the fuel cell stop mode (e.g., the fuel cell system switching or transitioning to the fuel cell stop).

At this time, the reason for determining the rotational speed of the pump depending on the insulation resistance deviation (e.g., a difference between the measured insulation resistance deviates and a threshold value) and the vehicle speed is to circulate an amount of the coolant required for insulation resistance recovery to the ion filter 50 depending on a measured insulation resistance level.

For this purpose, the rotational speed of the pump required for insulation resistance recovery, for example, the rotational speed of the pump to circulate the amount of the coolant required for insulation resistance recovery to the ion filter 50, may be determined by a quadratic equation described in Equation 1 below based on the insulation resistance deviation.

y=ax²+bx+c [Equation 1]

In Equation 1 above, x is the insulation resistance deviation (predetermined insulation resistance upper limit reference value-n-time moving average of insulation resistances measured immediately before entering the fuel cell stop), y is the determined rotational speed of the pump required for insulation resistance recovery, and a, b, and c are coefficients obtained from the pump rotational speed data obtained through tests (e.g., pump rotational speed data required for insulation resistance recovery), respectively.

For example, an amount of the coolant passing through the ion filter 50 for insulation resistance recovery depending on the measured insulation resistance level may be determined through testing. An amount of the coolant passing through the ion filter 50 for recovery of insulation resistance of 500 kOhm may be determined to be 60 L (liter), an amount of the coolant passing through the ion filter 50 for recovery of insulation resistance of 300 kOhm may be determined to be 30 L (liter), and pump rotational speed data to circulate the determined amounts of the coolant to the ion filter 50 may also be obtained through testing.

In addition, the controller 100 variably determines the rotational speed of the pump required for insulation resistance recovery by reflecting a vehicle speed factor v in a determined pump rotational speed value required for insulation resistance recovery.

For example, assuming that a vehicle speed between 0 and 30 kph is a low speed, a vehicle speed between 30 and 100 kph is a medium speed, and a vehicle speed of 100 kph or higher is a high speed in the fuel cell vehicle, the vehicle speed factor v may be determined as 0 at the low speed and 1 at the high speed, and the vehicle speed factor v at the medium speed may be variably determined depending on a current vehicle speed ratio within the range of the minimum vehicle speed of 30 kph and the maximum vehicle speed of 100 kph, as below.
Vehicle Speed Factor v at Low Vehicle Speed=(Current Vehicle Speed Minimum Vehicle Speed (30 kph))/(Maximum Vehicle Speed (100 kph)−Minimum Vehicle Speed (30 kph))

For this purpose, the processor 102 of the controller 100 may be configured to variably determine the rotational speed of the pump by reflecting the vehicle speed factor v in the pump rotational speed value determined based on the insulation resistance deviation obtained by subtracting the n-time moving average of insulation resistances measured immediately before entering the fuel cell stop mode from the predetermined insulation resistance upper limit reference value.

Next, the first valve 41 and the second valve 42 are opened (e.g., fully opened) in the direction of circulating the coolant to the ion filter 50 by a control signal from the controller 100 so that the coolant may be circulated to the ion filter 50 to recover the insulation resistance in the fuel cell stop state, and the pump 30 is driven at the rotational speed of the pump determined in S105 (S106). The fuel cell stop state, in which fuel supply is cut off from the fuel cell stack of the fuel cell system and the fuel cell system does not generate or supply power (e.g., electricity) to the vehicle, may also be referred to as fuel cell stop mode, fuel cell inactive state or mode, fuel cell standby state or mode, fuel cell non-operating state or mode, fuel cell idle state or mode, fuel cell disengaged state or mode, etc.

Therefore, the coolant having circulated through the fuel cell stack 10 and radiator 20 may pass through the ion filter 50 by driving the pump 30 in the fuel cell stop state, as shown in FIG. 2, so that metal ions may be removed from the coolant by the ion exchange resin in the ion filter 50, and accordingly, the electrical conductivity of the coolant may be controlled to be reduced to below a certain level, and thus, the insulation resistance of the fuel cell system may be restored.

In this way, the insulation resistance recovery control in which the coolant passes through the ion filter 50 in the fuel cell stop mode where the fuel cell stack does not generate power is performed so that the insulation resistance of the fuel cell system may be restored, and in addition, the coolant having been circulated through the fuel cell stack with no heat generation in the fuel cell stop mode is controlled to a temperature required to ensure the durability of the ion filter 50 or lower and passes through the ion filter 50 so that the ion filter 50 may be used until a target durability time, and accordingly, premature replacement of the ion filter 50 may be prevented.

In addition, since the pump rotational speed to circulate the coolant to the ion filter 50 in the fuel cell stop mode is determined based on the insulation resistance deviation and the vehicle speed as in S105 described above, it is possible to avoid energy efficiency loss and noise generation due to over-operation of the pump 30.

Next, during the insulation resistance recovery control, the controller 100 determines whether a release condition for the insulation resistance recovery control is satisfied (S107).

For example, it may be determined that the release condition for the insulation resistance recovery control is satisfied, when the operating state of the fuel cell system transitions from the fuel cell stop state to the fuel cell run state, or when the insulation resistance recovery control in which the coolant passes through the ion filter 50 in the fuel cell stop mode is performed for a time exceeding a predetermined time.

For this purpose, the processor 102 of the controller 100 may be configured to determined that the release condition for the insulation resistance recovery control is satisfied, when the operating state of the fuel cell system transitions from the fuel cell stop state to the fuel cell run state, or when insulation resistance recovery control in which the coolant passes through the ion filter 50 in the fuel cell stop mode is performed for a time exceeding the predetermined time.

Then, when the release condition for the insulation resistance recovery control is satisfied, the controller 100 compares an insulation resistance measured again by the insulation resistance monitor 110 with the predetermined insulation resistance upper limit reference value.

In other words, the controller 100 determines whether a value obtained by subtracting the predetermined insulation resistance upper limit reference value from the insulation resistance measured by the insulation resistance monitor 110 after the insulation resistance recovery control exceeds 0 (zero) (e.g., whether the insulation resistance measured by the insulation resistance monitor 110 after the insulation resistance recovery control is greater than the predetermined insulation resistance upper limit reference value) (S108).

Accordingly, when the insulation resistance measured by the insulation resistance monitor 110 exceeds the predetermined insulation resistance upper limit reference value as a result of the determination in S108, the controller 100 determines that the insulation resistance recovery control by the ion filter 50 is unnecessary.

At this time, when it is determined that the insulation resistance recovery control by the ion filter 50 is unnecessary, the first valve 41 and the second valve 42 may be controlled to be open in the direction of circulating the coolant to the fuel cell stack by a control signal from the controller 100 so that the coolant may be circulated to the fuel cell stack in the subsequent fuel cell run state.

On the other hand, when the insulation resistance measured by the insulation resistance monitor 110 does not exceed the predetermined insulation resistance upper limit reference value as the result of the determination in S108, the insulation resistance recovery control may be performed again when the fuel cell system enters the fuel cell stop later.

On the contrary, after it is determined that the insulation resistance recovery control by the ion filter 50 is necessary as the result of the determination in S102, even if the fuel cell system does not enter the fuel cell stop, forced insulation resistance recovery control may be determined to be executed.

For this purpose, after it is determined that the insulation resistance recovery control by the ion filter 50 is necessary as the result of the determination in S102, when a non-entry state to the fuel cell stop is maintained for a time exceeding a predetermined waiting time, the controller 100 determines execution of the forced insulation resistance recovery control in which the coolant is forcibly circulated to the ion filter 50 (S109).

Subsequently, when the execution of the forced insulation resistance recovery control is determined, the controller 100 secures a cooling margin by setting a current target cooling temperature (e.g., 60 °C) of the fuel cell system to be lowered to a target temperature for securing the cooling margin (e.g., 50 °C) as a preliminary procedure for determining an execution time of the forced insulation resistance recovery control, and determines the execution time of the forced insulation resistance recovery control using the secured cooling margin (S110).

For example, the execution time t of the forced insulation resistance recovery control may be determined from the following cooling margin [kJ] and current amount of heat generated per unit time of the stack [kJ/s].
Cooling Margin [kJ]=Heat Capacity (Heat Capacity of Coolant in Fuel Cell Stack and Coolant Circulation Pipe) [kJ/°C]×{(Current Target Cooling Temperature (e.g., 60 °C)−Target Temperature for Securing Cooling Margin (e.g., 50 °C)}
Current Amount of Heat Generated per Unit Time of Stack [kJ/s]=(Open Circuit Voltage (OCV)×Number of Cells of Stack−Stack Voltage (Vₛₜₖ)×Stack Current (Iₛₜₖ)/1000 [kJ/s]
Execution Time of Forced Insulation Resistance Recovery Control (t)=Cooling Margin [kJ]/Current Amount of Heat Generated per Unit Time of Stack [kJ/s]

Because the ion filter 50 must be used at a certain temperature or lower in order to satisfy a durability condition due to the hardware characteristics of the ion filter 50, a target cooling margin value that satisfies a heat capacity condition may be set in order to satisfy this usage condition.

Next, as in S105, the controller 100 determines a rotational speed of the pump depending on the insulation resistance deviation and the vehicle speed using Equation 1 above.

However, in Equation 1, the insulation resistance deviation x may be substituted as a value obtained by subtracting the n-time moving average of insulation resistances that may be measured in real time in the fuel cell run state from the predetermined insulation resistance upper limit reference value.

For this purpose, the processor 102 of the controller 100 may be configured to determine a pump rotational speed based on the insulation resistance deviation and the vehicle speed for the forced insulation resistance recovery control, when the non-entry state to the fuel cell stop is maintained for a time exceeding the predetermined waiting time.

More specifically, the processor 102 of the controller 100 may be configured to secure the cooling margin by setting the current target cooling temperature of the fuel cell system to be lowered to the target temperature for securing the cooling margin, determine the execution time of the forced insulation resistance recovery control using the secured cooling margin, determine the pump rotational speed based on the insulation resistance deviation and the vehicle speed for the forced insulation resistance recovery control, and variably determine the rotational speed of the for driving the pump 30 by reflecting the vehicle speed factor in the pump rotational speed value determined based on the insulation resistance deviation obtained by subtracting the n-time moving average of insulation resistances measured in real time in the fuel cell run state from the predetermined insulation resistance upper limit reference value.

Next, the first valve 41 and the second valve 42 may be opened (e.g., fully opened) in the direction of circulating the coolant to the ion filter 50 during the execution time t of the forced insulation resistance recovery control based on a control signal for the insulation resistance forced recovery from the controller 100 and the pump 30 may be driven at the above-determined rotational speed of the pump, so that the coolant may be circulated to the ion filter 50 to perform insulation resistance recovery even in the non-entry state to the fuel cell stop (S106).

Therefore, the coolant passes through the ion filter 50 by driving the pump 30 during the execution time t of the forced insulation resistance recovery control even in the non-entry state to the fuel cell stop, so that metal ions may be removed from the coolant by the ion exchange resin filling the inside of the ion filter 50, and accordingly, the electrical conductivity of the coolant may be controlled to be reduced to below a certain level, and thus, the insulation resistance of the fuel cell system may be restored.

Next, the controller 100 determines whether a release condition for the forced insulation resistance recovery control is satisfied.

In detail, the controller 100 determines whether a current coolant temperature exceeds a target cooling temperature, the execution time t of the forced insulation resistance recovery control has elapsed, or the insulation resistance measured by the insulation resistance monitor 110 exceeds the predetermined insulation resistance upper limit reference value (S111).

As a result of the determination, when the current coolant temperature exceeds the target cooling temperature, the execution time t of the forced insulation resistance recovery control has elapsed, or the insulation resistance measured by the insulation resistance monitor 110 exceeds the predetermined insulation resistance upper limit reference value, the controller 100 determines that the release condition for the forced insulation resistance recovery control is satisfied and terminates the forced insulation resistance recovery control.

For this purpose, the processor 102 of the controller 100 may be configured to determine that the release condition for the forced insulation resistance recovery control is satisfied when the current coolant temperature exceeds the target cooling temperature, the execution time of the forced insulation resistance recovery control has elapsed, or the insulation resistance measured by the insulation resistance monitor exceeds the predetermined insulation resistance upper limit reference value.

Subsequently, when the release condition for the forced insulation resistance recovery control is satisfied, the controller 100 compares an insulation resistance measured again by the insulation resistance monitor 110 with the predetermined insulation resistance upper limit reference value.

In other words, the controller 100 determines whether a value obtained by subtracting the predetermined insulation resistance upper limit reference value from the insulation resistance measured by the insulation resistance monitor 110 after the forced insulation resistance recovery control exceeds 0 (zero) (e.g., whether the insulation resistance measured by the insulation resistance monitor 110 after the forced insulation resistance recovery control is greater than the predetermined insulation resistance upper limit reference value) (S108).

When the insulation resistance measured by the insulation resistance monitor 110 exceeds the predetermined insulation resistance upper limit reference value as a result of the determination, the controller 100 determines that the insulation resistance recovery control by the ion filter 50 is unnecessary.

At this time, when the forced insulation resistance recovery control by the ion filter 50 is terminated, the first valve 41 and the second valve 42 may be controlled to be open in the direction of circulating the coolant to the fuel cell stack by a control signal from the controller 100 so that the coolant may be circulated to the fuel cell stack in the fuel cell run state.

On the other hand, when the insulation resistance measured by the insulation resistance monitor 110 does not exceed the predetermined insulation resistance upper limit reference value as the result of the determination in S108, the insulation resistance recovery control may be performed again when the fuel cell system enters the fuel cell stop later.

In this way, after the insulation resistance recovery control by the ion filter 50 is determined to be necessary, even in the non-entry state to the fuel cell stop, the insulation resistance of the fuel cell system may be restored based on the execution of the forced insulation resistance recovery control.

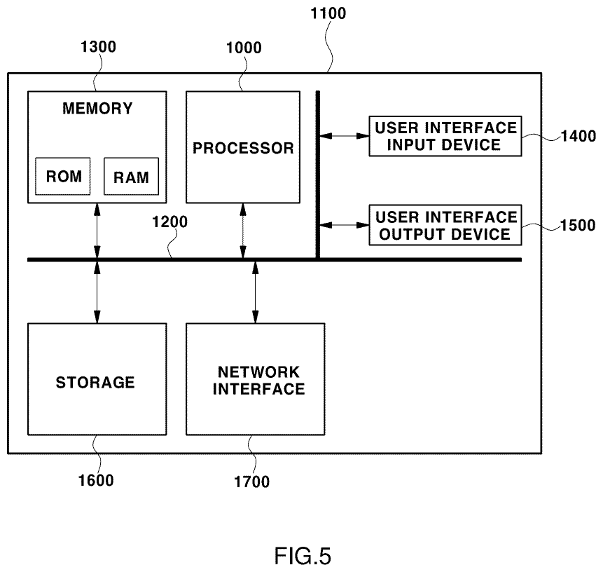

FIG. 5 shows an example computing system (e.g., a computing device of a vehicle or any other apparatus). One or more controllers, processors, etc. described herein (e.g., the controller 100, the insulation resistor monitor 110, etc.) may be implemented by the computing system or may be implemented in the computing system.

A computing system (also referred to as a computer, a computing device, etc.) 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example embodiment(s) disclosed in the specification may be directly implemented with a hardware module, a software module, or a combination of the hardware module and the software module, which is executed by the processor 1100. The software module may reside on a storage medium (i.e., the memory 1300 and/or the storage 1600) such as RAM, a flash memory, ROM, an erasable and programmable read-only memory (EPROM), an electrically erasable and programmable read-only memory (EEPROM), a register, a hard disk drive, a removable disc, or a compact disc read-only memory (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

In one aspect, the present disclosure provides an insulation resistance recovery control method of a fuel cell including monitoring, by an insulation resistance monitor, insulation resistance of a fuel cell system, determining, by a controller, whether insulation resistance recovery control is necessary based on a result of the monitoring of the insulation resistance, determining, by the controller, an RPM of a pump based on an insulation resistance deviation and a vehicle speed based on confirming entrance of the fuel cell system to a fuel cell stop state, after the insulation resistance recovery control is determined to be necessary, and fully opening a valve in a direction of circulating a coolant to an ion filter by a control signal from the controller, and driving the pump at the determined pump RPM, as the insulation resistance recovery control.

In determining whether the insulation resistance recovery control is necessary, the insulation resistance recovery control may be determined to be necessary based on determining that the insulation resistance measured by the insulation resistance monitor in a fuel cell run state is less than a predetermined insulation resistance lower limit reference value.

Based on confirming entrance of the fuel cell system to the fuel cell stop state, the controller may compare an average temperature of the coolant with a set temperature configured to ensure durability of the ion filter, and determine the pump RPM based on determining that a value obtained by subtracting the set temperature configured to ensure the durability of the ion filter from the average temperature of the coolant is less than 0.

The pump RPM may be variably determined by reflecting a vehicle speed factor in a pump RPM value determined based on the insulation resistance deviation obtained by subtracting an n-time moving average of insulation resistances measured immediately before entering the fuel cell stop state from a predetermined insulation resistance upper limit reference value.

The insulation resistance recovery control method may further include determining, by the controller, whether a release condition for the insulation resistance recovery control is satisfied during the insulation resistance recovery control, and the release condition for the insulation resistance recovery control may be determined to be satisfied based on determining that an operating state of the fuel cell system transitions from the fuel cell stop state to a fuel cell run state, or the insulation resistance recovery control configured such that the coolant passes through the ion filter in a fuel cell stop is performed for a time exceeding a predetermined time.

Based on determining that the release condition for the insulation resistance recovery control is satisfied, the controller may compare the insulation resistance measured by the insulation resistance monitor with a predetermined insulation resistance upper limit reference value, determine that the insulation resistance recovery control is unnecessary based on determining that the measured insulation resistance exceeds the predetermined insulation resistance upper limit reference value, and perform the insulation resistance recovery control again upon subsequently entering the fuel cell stop state based on determining that the measured insulation resistance does not exceeds the predetermined insulation resistance upper limit reference value.

In another aspect, the present disclosure provides an insulation resistance recovery control method of a fuel cell including monitoring, by an insulation resistance monitor, insulation resistance of a fuel cell system, determining, by a controller, whether insulation resistance recovery control is necessary based on a result of the monitoring of the insulation resistance, determining, by the controller, an RPM of a pump based on an insulation resistance deviation and a vehicle speed for forced insulation resistance recovery control based on determining that a non-entry state of the fuel cell system to a fuel cell stop state is maintained for a time exceeding a predetermined waiting time, after the insulation resistance recovery control is determined to be necessary, and fully opening a valve in a direction of circulating a coolant to an ion filter for an execution time of the forced insulation resistance recovery by a control signal from the controller, and driving the pump at the determined pump RPM.

In determining whether the insulation resistance recovery control is necessary, the insulation resistance recovery control may be determined to be necessary based on determining that the insulation resistance measured by the insulation resistance monitor is less than a predetermined insulation resistance lower limit reference value.

The insulation resistance recovery control method may further include securing a cooling margin by setting a current target cooling temperature of the fuel cell system to be lowered to a target temperature configured to secure the cooling margin, and determining the execution time of the forced insulation resistance recovery control using the secured cooling margin.

The pump RPM may be variably determined by reflecting a vehicle speed factor in a pump RPM value determined based on the insulation resistance deviation obtained by subtracting an n-time moving average of insulation resistances measured in real time in a fuel cell run state from a predetermined insulation resistance upper limit reference value.

The insulation resistance recovery control method may further include determining, by the controller, whether a release condition for the forced insulation resistance recovery control is satisfied during the forced insulation resistance recovery control, and the release condition for the forced insulation resistance recovery control may be determined to be satisfied based on determining that a current coolant temperature exceeds a target cooling temperature, the execution time of the forced insulation resistance recovery control has elapsed, or the insulation resistance measured by the insulation resistance monitor exceeds a predetermined insulation resistance upper limit reference value.

Based on determining that the release condition for the forced insulation resistance recovery control is satisfied, the controller may compare the insulation resistance measured by the insulation resistance monitor with a predetermined insulation resistance upper limit reference value, determine that the insulation resistance recovery control is unnecessary based on determining that the measured insulation resistance exceeds the predetermined insulation resistance upper limit reference value, and perform the insulation resistance recovery control again upon subsequently entering the fuel cell stop state based on determining that the measured insulation resistance does not exceeds the predetermined insulation resistance upper limit reference value.

In yet another aspect, the present disclosure provides an insulation resistance recovery control apparatus of a fuel cell including an insulation resistance monitor configured to monitor insulation resistance of a fuel cell system, and a controller having at least one processor configured to determine whether insulation resistance recovery control is necessary based on a result of the monitoring of the insulation resistance, determining an RPM of a pump based on an insulation resistance deviation and a vehicle speed for the insulation resistance recovery control or forced insulation resistance recovery control, and fully opening a valve in a direction of circulating a coolant to an ion filter and driving the pump at the determined pump RPM to perform the insulation resistance recovery control or the forced insulation resistance recovery control.

The processor may be configured to determine the pump RPM based on the insulation resistance deviation and the vehicle speed for the insulation resistance recovery control based on confirming entrance of the fuel cell system to a fuel cell stop state, after the insulation resistance recovery control is determined to be necessary, or is configured to determine the pump RPM based on the insulation resistance deviation and the vehicle speed for the forced insulation resistance recovery control based on determining that a non-entry state of the fuel cell system to a fuel cell stop state is maintained for a time exceeding a predetermined waiting time, after the insulation resistance recovery control is determined to be necessary.

The processor may be configured to determine the pump RPM based on determining that a value obtained by subtracting a set temperature configured to ensure durability of the ion filter from an average temperature of the coolant is less than 0 based on confirming entrance of the fuel cell system to the fuel cell stop state, and to variable determine the pump RPM by reflecting a vehicle speed factor in a pump RPM value determined based on the insulation resistance deviation obtained by subtracting an n-time moving average of insulation resistances measured immediately before entering the fuel cell stop state from a predetermined insulation resistance upper limit reference value.

The processor may be configured to secure a cooling margin by setting a current target cooling temperature of the fuel cell system to be lowered to a target temperature configured to secure the cooling margin, to determine an execution time of the forced insulation resistance recovery control using the secured cooling margin, to determine the pump RPM based on the insulation resistance deviation and the vehicle speed for the forced insulation resistance recovery control, and to variably determine the pump RPM by reflecting a vehicle speed factor in a pump RPM value determined based on the insulation resistance deviation obtained by subtracting an n-time moving average of insulation resistances measured in real time in a fuel cell run state from a predetermined insulation resistance upper limit reference value.

The processor may be configured to determine that a release condition for the insulation resistance recovery control is satisfied based on determining that an operating state of the fuel cell system transitions from the fuel cell stop state to a fuel cell run state, or the insulation resistance recovery control configured such that the coolant passes through the ion filter in a fuel cell stop section is performed for a time exceeding a predetermined time, during the insulation resistance recovery control.

The processor may be configured to determine that a release condition for the forced insulation resistance recovery control is satisfied based on determining that a current coolant temperature exceeds a target cooling temperature, an execution time of the forced insulation resistance recovery control has elapsed, or the insulation resistance measured by the insulation resistance monitor exceeds a predetermined insulation resistance upper limit reference value, during the forced insulation resistance recovery control.

As is apparent from the above description, the present disclosure provides the following effects through means for solving the above-mentioned problems.

First, insulation resistance recovery using an ion filter is performed in a fuel cell stop mode so that the insulation resistance of a fuel cell system may be restored, and a coolant is concentratedly circulated to a fuel cell stack instead of being circulated to the ion filter in a fuel cell run mode so that the cooling loss of the fuel cell stack may be prevented, thereby being capable of improving cooling performance.

Second, insulation resistance recovery control using the ion filter is performed in the fuel cell stop mode in which the fuel cell stack does not generate power so that the coolant having been circulated through the fuel cell stack without heat generation is adjusted to a temperature required to ensure the durability of the ion filter or lower and then passes through the ion filter, and thus, the ion filter may be used until a target durability time, and accordingly, premature replacement of the ion filter may be prevented.

Third, the RPM of a pump to circulate the coolant to the ion filter in the fuel cell stop mode is determined depending on an insulation resistance deviation and a vehicle speed, thereby being capable of preventing energy efficiency loss and noise generation due to over-operation of the pump.

Although one or more example embodiments of the present disclosure have been described in detail above, the scope of the present disclosure is not limited thereto, and various modifications and improvements made by those skilled in the art using the basic concept of the present disclosure defined in the following claims are also included in the scope of the present disclosure.

What is claimed is:

1. A method performed by an apparatus of a vehicle, the method comprising:
measuring an insulation resistance value of a fuel cell system of the vehicle;
determining, based on the insulation resistance value, whether insulation resistance recovery control is necessary;
determining a rotational speed of a pump of the fuel cell system based on determining that the insulation resistance recovery control is necessary, based on the fuel cell system transitioning to an inactive mode, based on a difference between the insulation resistance value and a threshold value, and based on a vehicle speed of the vehicle; and
performing the insulation resistance recovery control by sending one or more control signals for:
opening a valve, of the fuel cell system, that directs a coolant in the fuel cell system to an ion filter; and
operating the pump at the determined rotational speed.

2. The method of claim 1, wherein the determining of whether the insulation resistance recovery control is necessary comprises:
determining that the insulation resistance recovery control is necessary based on the insulation resistance value, measured while the fuel cell system is in an active mode, is less than a predetermined insulation resistance lower limit.

3. The method of claim 1, wherein the determining of the rotational speed comprises:
determining the rotational speed further based on determining that an average temperature of the coolant is less than a threshold temperature.

4. The method of claim 1, wherein the determining of the rotational speed comprises:
determining the rotational speed further based on a difference between a predetermined quantity of moving averages of insulation resistance values, measured before the fuel cell system transitions to the inactive mode, and a predetermined insulation resistance upper limit.

5. The method of claim 1, further comprising:
determining, during the insulation resistance recovery control, whether a release condition for the insulation resistance recovery control is satisfied.

6. The method of claim 5, wherein the release condition for the insulation resistance recovery control comprises at least one of:
the fuel cell system transitioning from the inactive mode to an active mode, or
the coolant passing through the ion filter for at least a predetermined time duration while the fuel cell system is in the inactive mode.

7. The method of claim 5, wherein the insulation resistance recovery control is first insulation resistance recovery control, and wherein the method further comprises:
based on determining that the release condition is satisfied, comparing a second insulation resistance value, measured after the first insulation resistance recovery control, with a predetermined insulation resistance upper limit; and
performing one of:
based on the second insulation resistance value being less than the predetermined insulation resistance upper limit and based on the fuel cell system transitioning to the inactive mode after the first insulation resistance recovery control, second insulation resistance recovery control, or
based on the second insulation resistance value being greater than the predetermined insulation resistance upper limit, determining that the second insulation resistance recovery control is unnecessary.

8. A method performed by an apparatus of a vehicle, the method comprising:
measuring an insulation resistance value of a fuel cell system of the vehicle;
determining, based on the insulation resistance value, whether insulation resistance recovery control is necessary;
determining a rotational speed of a pump of the fuel cell system based on a difference between the insulation resistance value and a threshold value, based on a vehicle speed of the vehicle, and based on determining that the fuel cell system remains in an inactive mode for at least a predetermined waiting time duration after determining that the insulation resistance recovery control is necessary; and
performing, for an execution time duration, the insulation resistance recovery control by sending one or more control signals for:
opening a valve, of the fuel cell system, that directs a coolant in the fuel cell system to an ion filter; and
operating the pump at the determined rotational speed.

9. The method of claim 8, wherein the determining of whether the insulation resistance recovery control is necessary comprises:
determining that the insulation resistance recovery control is necessary based on the insulation resistance value being less than a predetermined insulation resistance lower limit.

10. The method of claim 8, further comprising:
lowering a target cooling temperature of the fuel cell system by a cooling margin; and
determining, based on the cooling margin, the execution time duration.

11. The method of claim 8, wherein the determining of the rotational speed comprises:
determining the rotational speed further based on a difference between a predetermined quantity of moving averages of insulation resistance values, measured while the fuel cell system is in an active mode, and a predetermined insulation resistance upper limit.

12. The method of claim 8, further comprising:
determining, during the insulation resistance recovery control, whether a release condition for the insulation resistance recovery control is satisfied.

13. The method of claim 12, wherein the release condition for the insulation resistance recovery control comprises at least one of:
a current coolant temperature of the coolant in the fuel cell system exceeding a target cooling temperature,
elapsing of the execution time duration, or
the insulation resistance value exceeding a predetermined insulation resistance upper limit.

14. The method of claim 12, wherein the insulation resistance recovery control is first insulation resistance recovery control, and wherein the method further comprises:
based on determining that the release condition is satisfied, comparing a second insulation resistance value, measured after the first insulation resistance recovery control, with a predetermined insulation resistance upper limit; and
performing one of:
based on the second insulation resistance value being less than the predetermined insulation resistance upper limit and based on the fuel cell system transitioning to the inactive mode after the first insulation resistance recovery control, second insulation resistance recovery control, or
based on the second insulation resistance value being greater than the predetermined insulation resistance upper limit, determining that the second insulation resistance recovery control is unnecessary.

15. An apparatus comprising:
an insulation resistance sensor configured to monitor insulation resistance of a fuel cell system of a vehicle;
a processor; and
a memory storing at least one instruction that is configured to be executed by the processor to cause the apparatus to:
receive, from the insulation resistance sensor, an insulation resistance value of the fuel cell system;
determine, based on the insulation resistance value, whether insulation resistance recovery control is necessary;
determine a rotational speed of a pump of the fuel cell system based on a difference between the insulation resistance value and a threshold value, and based on a vehicle speed of the vehicle; and
perform the insulation resistance recovery control by sending one or more control signals for:
opening a valve, of the fuel cell system, that directs a coolant in the fuel cell system to an ion filter; and
operating the pump at the determined rotational speed.

16. The apparatus of claim 15, wherein the at least one instruction is configured to be executed by the processor to cause the apparatus to determine the rotational speed by one of:
determining the rotational speed further based on the fuel cell system transitioning to an inactive mode, and based on determining that the insulation resistance recovery control is necessary, or
determining the rotational speed further based on determining that the fuel cell system remains in the inactive mode for at least a predetermined waiting time duration after determining that the insulation resistance recovery control is necessary.

17. The apparatus of claim 15, wherein the at least one instruction is configured to be executed by the processor to cause the apparatus to determine the rotational speed by:
determining the rotational speed further based on determining that an average temperature of the coolant is less than a threshold temperature, based on the fuel cell system transitioning to an inactive mode, and based on a difference between a predetermined quantity of moving averages of insulation resistance values, measured before the fuel cell system transitions to the inactive mode, and a predetermined insulation resistance upper limit.

18. The apparatus of claim 15, wherein the at least one instruction is configured to be executed by the processor to further cause the apparatus to:
lower a target cooling temperature of the fuel cell system by a cooling margin; and
determine, based on the cooling margin, an execution time duration of the insulation resistance recovery control, and
wherein the at least one instruction is configured to be executed by the processor to cause the apparatus to determine the rotational speed by:
determining the rotational speed further based on a difference between a predetermined quantity of moving averages of insulation resistance values, measured while the fuel cell system is in an active mode, and a predetermined insulation resistance upper limit.

19. The apparatus of claim 15, wherein the at least one instruction is configured to be executed by the processor to further cause the apparatus to:
determine, during the insulation resistance recovery control, that a release condition for the insulation resistance recovery control is satisfied based on at least one of:
the fuel cell system transitioning from an inactive mode to an active mode, or
the coolant passing through the ion filter for at least a predetermined time duration while the fuel cell system is in the inactive mode.

20. The apparatus of claim 15, wherein the at least one instruction is configured to be executed by the processor to further cause the apparatus to:
determine, during the insulation resistance recovery control, that a release condition for the insulation resistance recovery control is satisfied based on at least one of:
a current coolant temperature of the coolant in the fuel cell system exceeding a target cooling temperature,
elapsing of an execution time duration of the insulation resistance recovery control, or
the insulation resistance value exceeding a predetermined insulation resistance upper limit.
